(19) United States
(12) Patent Application Publication
(10) Pub. No.: US 2009/0277972 A1
(43) Pub. Date: Nov. 12, 2009

(54) WILDLIFE SCENT FORMULATION

(76) Inventors: Rickey L. Kennon, Hernando, MS (US); Greg McManic, Memphis, TN (US)

Correspondence Address: ASHLEY LAW FIRM P.C., 3440 TORINGDON WAY, SUITE 205, CHARLOTTE, NC, 28277, US

(21) Appl. No.: 12/207,629

(22) Filed: Sep. 10, 2008

Related U.S. Application Data
(63) Continuation-in-part of application No. 12/117,385, filed on May 8, 2008.

(51) Int. Cl. A01N 25/18; A01P 19/00

(52) U.S. Cl. 239/6; 424/84

(57) ABSTRACT

A scent formulation can include a scent emitting substance, an oil and a surfactant. The scent formulation can be used to attract and/or repell wildlife, as well as to mask a hunter's scent. The scent emitting substance can be fox urine, coyote urine, deer urine, elk urine, moose urine, bear urine, rabbit urine, fish oils, sheep manure and/or mixtures thereof. The scent formulation can be comprised of a stable emulsion, in which the scent emitting substance and the oil do not separate into layers. The scent formulation can be used in a vaporizing device, in which the scent formulation is dispersed as a visible fog that leaves a film upon contact.

### CROSS REFERENCE TO RELATED APPLICATIONS

This application is a continuation-in-part of application Ser. No. 12/117,385, filed May 8, 2008, which is incorporated herein by reference.

### TECHNICAL FIELD AND BACKGROUND OF THE INVENTION

The present invention relates to the use of scents to attract and/or repel animals, and/or to cover other scents. Embodiments of the invention include liquid animal lures, repellants and/or cover scent formulations, which can exhibit stability in the presence of an oil and/or non-water soluble diluents. Various embodiments of the present invention may be in the form of a water emulsion, dispersion, or reverse phase emulsions, emulsifiable concentrates (EC) formulations, microemulsifiable concentrates (MEC), and the like.

Animal scents have been used by hunters for a number of different purposes. A primary reason animal scents are used is to attract wildlife to a desired area. Pursuant to the same objective, animal scents can also be used to mask the human scent of the hunters. Many animals possess an extremely keen sense of smell that can detect a human's scent from great distances. When they do so, the animals generally avoid the area in which the human is located.

A number of man-made animal scent formulations and scent related devices have been developed to assist hunters. For example, U.S. Pat. No. 4,944,940 to Christenson, II teaches an animal scent formulation, in which the urines from a number of different animals are blended together. U.S. Pat. No. 5,672,342 to Bell discloses an animal scent kit made from urine collected from a single animal and packaged for storage prior to use.

Such animal scents are often applied to target surfaces through the use of liquids which are known and have been used for many years to lure animals. Animals such as deer and elk. Typically, the scents are applied to an applicator used in hunting or repelling the animals, and are 100% undiluted lure, such as male or female deer urine. The urine is applied to a material and either placed on the ground or hung in the air, and the amount of sent released into the air is dependent on the surface area that the scent is applied and air flow through the material.

Another method of masking human scent that has been developed involves applying animal urine to a drag line attached to the hunter, and allowing the line to contact the ground, leaving a trail of animal scent behind. However, liquid animal scents used in this method often dissipate quickly. Furthermore, large quantities of urine are often wasted in an attempt to apply urine to a drag line.

Therefore, one of the inventors of the present application has invented a vaporizing device that can disperse an animal scent throughout a wide area. The vaporizing device is the subject of application Ser. No. 12,117,385, referenced above and incorporated herein. In using the vaporizing device, it has been discovered that it is preferable to utilize a scent formulation that contains oil. Applicants have discovered that such a formulation carries the scent further than formulations that do not include oil, and in addition, leaves a film over everything it comes in contact with that lasts longer than non-oil containing formulations. However, providing an animal scent formulation containing oil can be problematic, as urine and oil formulations are generally unstable, and typically will separate into layers.

### SUMMARY OF THE INVENTION

Therefore, it is an object of the present invention to provide a scent formulation that can be used by hunters to attract and/or repel animals, and/or to mask other scents.

Another object of the present invention is to provide an animal scent formulation that contains oil, and can be used in a vaporizing device.

These and other objects of the present invention can be achieved in the various embodiments of the invention disclosed below. One embodiment of the invention comprises a scent formulation comprising a scent emitting substance, an oil, and a surfactant, and the scent formulation is a substantially stable emulsion.

According to another embodiment of the invention, the scent formulation is adapted for being used in a vaporizing device, and the emulsion remains substantially stable for at least an amount of time in which the scent formulation is to be used in the vaporizing device.

According to another embodiment of the invention, the scent emitting substance can be animal urine, plant extract, artificial scent, natural scent and/or mixtures thereof.

According to another embodiment of the invention, the formulation is homogeneous, and the emulsion is a micro-emulsion or a macro-emulsion.

According to another embodiment of the invention, the scent emitting substance can be fox urine, coyote urine, deer urine, elk urine, moose urine, bear urine, rabbit urine, fish oils, sheep manure and/or mixtures thereof.

According to another embodiment of the invention, the formulation emits a scent that attracts at least one species of animals.

According to another embodiment of the invention, the formulation emits a scent that repels at least one species of animals.

According to another embodiment of the invention, the formulation emits a scent that masks a human scent.

According to another embodiment of the invention, the oil comprises paraffin oil, the scent emitting substance comprises deer urine, and the surfactant comprises a 6-mole ethylene oxide adduct of nonylphenol.

According to another embodiment of the invention, the scent formulation includes water, a tall oil fatty acid, and a high performance silicone defoamer.

According to another embodiment of the invention, the formulation is comprised of 10.0 percent by weight of paraffin oil, 20.0 percent by weight of deer urine, 4.0 percent by weight of surfactant, 2.0 percent by weight of a tall oil fatty acid, and 0.1 percent of a defoamer.

According to another embodiment of the invention, a liquid scent formulation for use in a vaporizing device in which the scent formulation is dispersed as a gas, comprises a scent emitting substance, an oil, and a surfactant. The formulation is a stable emulsion, in which the scent emitting substance and the oil does not separate into layers while the formulation is used with the vaporizing device.

According to another embodiment of the invention, the scent emitting substance is comprised fox urine, coyote urine, deer urine, elk urine, moose urine, bear urine, rabbit urine, wolf urine and/or mixtures thereof.

According to another embodiment of the invention, the scent formulation leaves a film upon contact when dispensed as a gas from the vaporizing device.

According to another embodiment of the invention, the scent formulation comprises a visible fog when dispersed from the vaporizing device.

According to another embodiment of the invention, a method of using a scent formulation includes providing a liquid scent formulation in a substantially stable emulsion comprising a scent emitting substance, at least one oil, and at least one surfactant, and a vaporizing device adapted for receiving the liquid scent formulation and emitting the scent formulation in a gaseous form is provided. The vaporizing device is filled with the liquid scent formulation, and the scent formulation is emitted from the vaporizing device to disperse the scent formulation in a desired area.

According to another embodiment of the present invention, there is provided a method for enhancing the dispersion and/or performance of a scent on a substrate by applying to the substrate a sufficient amount of a scent formulation in the form of a fog comprising a scent and oil in a storage stable formulation.

### BRIEF DESCRIPTION OF THE DRAWINGS

Objects of the invention are disclosed above. Other objects and advantages of the invention may appear as the description of the embodiments of the invention proceeds in conjunction with the drawings, in which:

FIG. 1 is a side view of the exterior of a vaporizing apparatus for use with a scent formulation according to an embodiment of the invention;

FIG. 2 is a side cut away view of the vaporizing apparatus of FIG. 1.

FIG. 3 is a side cut away view of a vaporizing apparatus for use with a scent formulation according to another embodiment of the invention; and

FIG. 4 is a side cut away view of a vaporizing apparatus for use with a scent formulation according to another embodiment of the invention.

### DETAILED DESCRIPTION OF THE PREFERRED EMBODIMENTS AND BEST MODE

A detailed description of various embodiments of the invention follows. It is to be understood that this description is illustrative and exemplary of various embodiments of the invention, and is made merely for the purposes of providing a full and enabling disclosure of the present invention. The detailed description herein of various embodiments is not intended, nor is to be construed, to limit the scope of patent protection afforded the present invention, which scope is to be defined by the claims and the equivalents thereof.

A scent formulation according to a preferred embodiment of the invention comprises at least one scent emitting substance, such as animal urine, plant extract and/or natural scent, in combination with at least one oil and a surfactant. The scent formulation can be a stable macro or micro-emulsion that exhibits enhanced storage stability. The formulation can attract or repel an animal. The urine can be fox urine, coyote urine, deer urine, elk urine, moose urine, bear urine, rabbit urine, and/or fish oils. The plant extracts can be selected from many natural or synthetic extracts, such as oak tree acorns and honeysuckle. The natural scents can be selected from many natural minerals, such as blends of sodium and/or calcium, and/or natural sugars such as honey and molasses.

In a preferred embodiment of the invention, the scent formulation comprises an emulsified composition comprising at least one animal scent and at least one of the following:
(a) vegetable oils, paraffinic oils, non water soluble diluents or solvents;
(b) fatty acids and blends thereof;
(c) esterified fatty acids or blends thereof;
(d) saponified fatty acids or blends thereof;
(e) N,N-dimethylamide of the formula

RCON(CH₃)₂
wherein R is an alkyl chain derived from a fatty acid having about 6 to about 18 carbon atoms; and
(f) polybutenes of the following formula

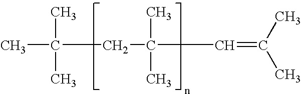

wherein “n” is a number from about 1 to about 50;
and/or at least one surfactant selected from the group consisting of
(a) fatty alkanolamides of the formula

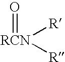

wherein R is an alkyl group having from about 6 to about 25 carbon atoms; R and R″ are the same or different and are independently selected from the group consisting of hydrogen,

—CH₂CH₂OH and

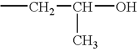

(b) polyethylene glycol (PEG) esters of the formula

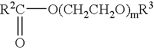

wherein R² is C₂-C₂₅ alkyl having from about 2 to about 25 carbon atoms, R³ is an alkyl having from about 2 to about 25 carbon atoms or hydrogen and m is a number from 1 to about 100,
(c) silicone surfactants of the formula

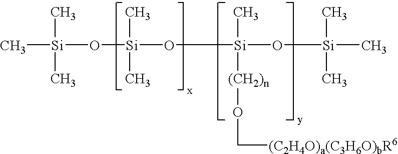

wherein “x” is a number from 0 to about 5, y is a number from 1 to about 5, “a” is a number from about 3 to about 25, “b” is a number from 0 to about 25, “n” is a number from about 2 to about 4, and R⁶ is hydrogen, an alkyl group having 1 to about 4 carbon atoms or an alkyl ester group having 1 to about 4 carbon atoms,
(d) ethoxylated fatty acids of the formula

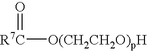

wherein R⁷ is an alkyl group having from about 6 to about 25 carbon atoms, “p” is a number from 1 to about 100,
(e) alkyl ethoxylates of the formula

R⁸O(CH₂CH₂O)_{q}H

wherein R⁸ is an alkyl group having from 1 to about 50 carbon atoms, and “q” is a number from 1 to about 100,
(f) alkylphenol ethoxylates of the formula

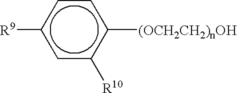

wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula

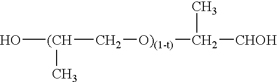

wherein “t” is a number from 1 to about 100,
(h) amine ethoxylates of the formula

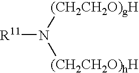

wherein “g” and “h” independently of one another are numbers from 1 to about 100 and R″ is an alkyl having from 1 to about 25 carbon atoms, and
(i) tristyrylphenol alkoxylate;
(j) a buffering agent in an amount sufficient to buffer the pH below about 9 and higher than about 2; and
(k) a fertilizer in the amount of 1.0% to 99%.

The scent formulation forms a stable solution. The scent formulation contains an oil, which are commonly used in oil concentrates such as vegetable oils, paraffinic oils, esterified seed oils, natural seed oils, synthetic paraffinic oils, fatty acids, low HLB surfactants, and other hydrophobic entities. The formulation also may contain nonionic surfactants, anionic surfactants, cationic surfactants, organosilicones, quaternary compounds, deposition agents and other surface-active agents. The adjuvant also may contain other functional agents including but not limited to defoamers, humectants and polymers.

As mentioned above, the scent formulation includes at least one animal urine and/or scent, at least one oil and a surfactant. The scent formulation exhibits enhanced storage stability when applied through a fogger.

The scent formulation can contain oils, surfactants, emulsifiers and/or other performance additives such as stickers and humectants. The surfactants can be nonionic, anionic surfactants, and/or cationic surfactants.

A scent formulation according to another embodiment of the invention is a liquid comprising oil and animal scent. Preferably, the animal scent is comprised of liquid animal urine. The oil is present in the composition between about 1-90% by weight (wt/wt), preferably between 40-60% by weight, and the animal urine is present in the formulation between about 1-90% by weight, preferably between about 10-50% by weight. The surfactant is present in the composition between about 10-50% by weight, preferably between about 25-35% by weight. Fox urine, coyote urine, deer urine, elk urine, moose urine, bear urine, rabbit urine, and fish oils are examples of liquid animal scents which can be used. The formulation remains is a stable oil and urine micro or macro-emulsion formulation.

The following are three examples of scent formulations according to embodiments of the invention, with all numbers representing the percent by weight of a particular component in each formulation:

Example #1

| | |
|---|---|
| Paraffin Oil | 10.0 |
| Surfactant* | 4.0 |
| Tall Oil Fatty Acid | 2.0 |
| H20 | 63.9 |
| Deer Urine | 20.0 |
| Defoamer** | 0.1 |

Example #2

| | |
|---|---|
| Paraffin oil | 10.0 |
| Surfactant* | 4.0 |
| Tall Oil Fatty Acid | 2.0 |
| Water | 63.88 |
| Deer Urine | 20.0 |
| Defoamer** | 0.1 |
| Permethrin | 0.02 |
| (pesticide or insecticide) | |

Example #3

| | |
|---|---|
| Paraffin Oil | 50 |
| Deer Urine | 20 |
| Sorbitan ester | 10 |
| Sorbatian ester ethoxylate | 10 |
| IPA salt of DDBSA | 10 |

*The surfactant in the above formulations is preferably a water dispersible nonionic surfactant comprised of a 6-mole ethylene oxide adduct of nonylphenol, such as is sold under the trade name ICONOL NP-6.
**The defoamer in the above formulations is preferably a high performance silicone antifoam emulsion, such as the defoamer sold under the trade name SAG 1572.

Suitable oil components include fatty acid esters, seed oils, petroleum oils, fatty acids, fatty alcohols, fatty ethers, fatty amides, synthetic oils and/or mixtures thereof. Fatty monocarboxylic acid esters, having the general formula R₂COOC_{N} H2_{N+1} wherein R₂ is an alkyl radical having from about 4 to about 22 carbon atoms, and “n” is a number from 1-4, can be used. They are derived by the esterification of a fatty acid with an alkanol. Preferred fatty acid esters are methyl and ethyl esters derived from the esterification of unsaturated fatty acids having from about 18 to 22 carbon atoms. Preferred methyl esters include methyl oleate, methyl laurate and methyl soyate. Preferred ethyl esters include ethyl oleate and ethyl canolate. Suitable fatty acids from which the fatty acid esters may be derived include coconut and other vegetable oils, and tallow.

Alkoxylated fatty acid esters may also be employed. These include fatty acid esters such as those listed above, which are alkoxylated with ethylene oxide, propylene oxide and combinations thereof.

Fatty alcohols, which may be employed in the present invention, are saturated or unsaturated, branch and/or linear C8-C20 alcohols. The fatty acids which may be employed in the present invention are those comprised of a chain of alkyl groups containing from 4 to 22 carbon atoms and characterized by a terminal carboxyl group. The fatty acids may be saturated such as, for example, butyric, lauric, palmitic and stearic or unsaturated such as, oleic, linoleic and linolenic.

The fatty ethers, which may be employed, are those generally derived from fatty alcohols, such as those listed above, by the elimination of water. They are generally characterized by the formula ROR wherein R is an alkyl group containing from 4 to 22 carbon atoms.

Similarly, the fatty amides which may also be employed are those characterized by the general formula R═CONH₂ wherein R is an alkyl group having from 4-22 carbon atoms.

Suitable seed oils are those derived from seeds and nuts and include castor, coconut, soybean, and the like. Preferred seed oil includes soybean oil.

Useful petroleum oil include petroleum, petroleum-derived oils and synthetic oils.

Suitable glycerides include those derived from glycerol and C6-22 fatty acid. Preferred glycerides include glycerol mono/di oleate.

Suitable nonionic surfactants for the use in the present invention include sugar surfactants, alkoxylated fatty alcohols, alkoxylated fatty acids, alkoxylated fatty acids, alkoxylated fatty ethers, alkoxylated fatty amides, ethoxylated seed oils, ethoxylated mineral oils, nonylphenol ethoxylates, alkoxylated alkyl phenols, ethoxylated glycerides, castor oil ethoxylates, and mixtures thereof.

Alkoxylated fatty alcohols include fatty alcohols such as those listed above which are alkoxylated with ethylene oxide, propylene oxide, and combinations thereof.

Alkoxylated fatty acids include fatty acids such as those listed above which are alkoxylated with ethylene oxide, propylene oxide and combinations thereof.

Alkoxylated fatty ethers include fatty ethers such as that list above, which are alkoxylated with ethylene oxide, propylene oxide and combinations thereof.

Alkoxylated fatty amides include fatty amides such as those listed above which are alkoxylated with ethylene oxide, propylene oxide and combinations thereof.

Suitable alcohols ethoxylates included C8-18 alcohols ethoxylated with from about 2 to about 30 moles of ethylene oxide.

Suitable ethoxylated seed oils include those containing from about 1 to about 200 moles of ethylene oxide.

Suitable nonylphenol ethoxylates include those ethoxylated with about 4 to about 70 moles of ethylene oxide. A preferred nonylphenol ethoxylated is a combination of a NP-9 with an NP-6.

Other surfactants that may be used include quaternary ammonium surfactants, ether amine surfactants, alkoxylated amine surfactants, secondary or tertiary alcohol surfactants, sorbitan fatty acid ester and amine, organosilicones surfactant, phosphate esters.

In a preferred method using the scent formulations of the invention, the scent formulations described above can be used in conjunction with a vaporizing device. The scent formulations of the embodiments of the invention described above contain urine and oil in a substantially stable emulsion, in which the urine and other non-oil based components and the oil do not separate from each other into layers, for at least a reasonable amount of time in which the scent formulation would typically be used in a vaporizing device. Applicants have discovered that oil containing scent formulations of the present invention can carry the scent further than scent formulations that do not include oil, and in addition, leave a film upon contact that lasts longer than non-oil containing formulations. Also, oil containing scent formulations of the present invention can produce a visible fog when used in the vaporizing device.

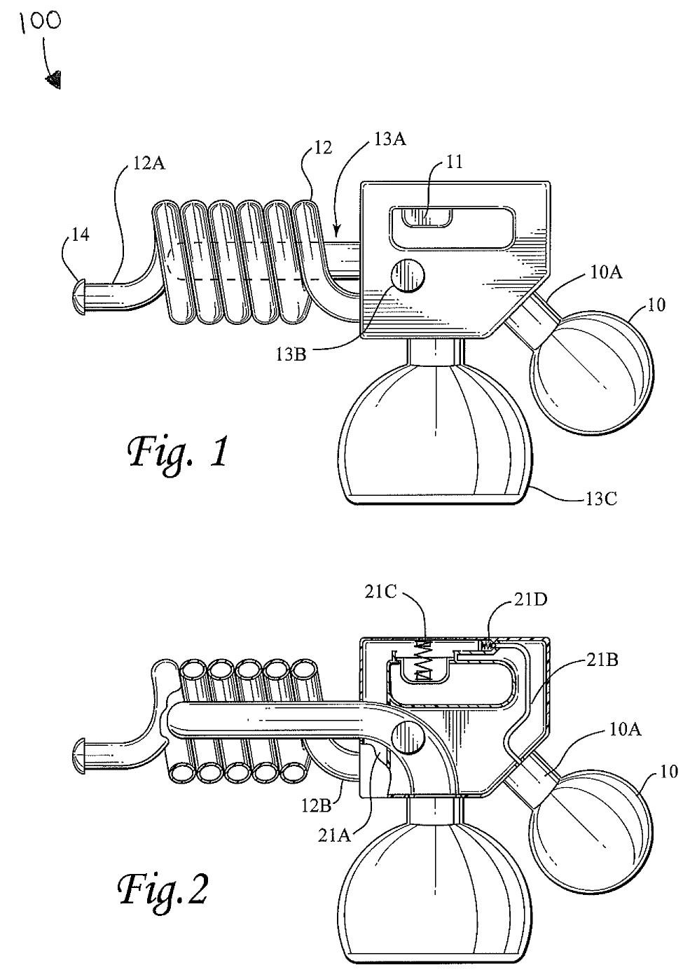

Referring now to the drawings, FIG. 1 illustrates a vaporizing device according to an embodiment, with which the scent formulations of the present invention may be used. FIG. 1 provides a side view of the vaporizing device, which is shown generally at reference numeral 100, and is referred to herein as a “Buck Fogger.” This embodiment of the Buck Fogger 100 is designed to be hand held and operated. A liquid scent formulation is stored in the scent reservoir 10. Preferably, the reservoir 10 has a volume of twenty to forty fluid ounces.

The scent formulation can include any scent that may attract deer to a given location, including but not limited to, deer urine, synthetic deer urine, deer hormones, sweet potato scent, corn scent, food scents, or any other scent or combination of scents that may attract deer to a given location. Alternatively, the user may use alternate scents tailored to attract other types of animals such as squirrels, birds, turkey, quail, rabbit, elk, or other animals. In another embodiment, scent formulation includes scents that repel deer. The user may also select scents that are known to repel other types of animals from a given area. For example, a farmer may use scents, either natural or synthetic, that certain animals find repulsive in order to prevent the animals from eating crops growing in gardens or rummaging in seed bins.

The scent reservoir 10 comprises an outlet 10A, which allows the liquid scent to be pumped out of the scent reservoir 10 and into the Buck Fogger 100. The flow of the liquid scent out of the scent reservoir is controlled by the control element 11. In this embodiment, the control element 11 comprises a manually operated trigger, which the user presses repeatedly to pump the liquid scent from the scent reservoir 10 and into the heating chamber 12. The operation of the control element 11 is discussed in greater detail below.

Once pumped into the heating chamber 12, the liquid scent from the scent reservoir 10 is retained by the heating chamber 12 while being vaporized by the heat from the heating element 13. The heating chamber should be constructed from a material that can withstand heat created by the heating element 13 used in a given embodiment of the Buck Fogger. In the preferred embodiment, the heating chamber 12 is constructed in a coil shape. The coil shape helps retain the liquid scent while the scent is in the liquid phase. Also, the coil shape increases the surface area of the heating chamber 12 that is exposed to the heat from the heating element 13. A greater exposed surface area increases the efficiency of the vaporization process. However, many other shapes may be used to perform this function.

The function of the heating element 13 is to produce heat to vaporize the liquid scent retained in the heating chamber 12. The heat producing portion of the heating element 13 must be placed in close proximity to the heating chamber 12 to cause the vaporization of the liquid scent retained in the heating chamber 12. In this embodiment, the heating element 13 comprises a burner element 13A, a striking element 13B, and a fuel element 13C. The fuel element 13C supplies fuel to the burner element 13A, the heat producing portion of the heating element. The fuel element 13C also retains the fuel while the Buck Fogger 100 is not in operation. The fuel element 13C should also be equipped with some valve to control the flow of fuel to the burner element 13A. In the present embodiment, the fuel used is propane, due to the fact that propane is easily available to most consumers. However, the present invention may use any fuel that burns at a temperature greater than the boiling point of the liquid scent to be vaporized. In the present embodiment, the burner element 13A mixes air with the fuel from the fuel element 13C. After the air and fuel are mixed, the burner element 13A can maintain a combustion reaction. The heat created by the combustion reaction in the burner element 13A of the heating element 13 raises the temperature of the heating chamber 12, causing the liquid scent held in the heating chamber to vaporize. The striking element 13B is present to ignite the air and fuel mix to begin the combustion reaction in the burner element 13A.

When the liquid scent formulation in the heating chamber 12 begins to vaporize, the air pressure in the heating chamber 12 will increase, forcing the scent vapor to move to the outlet 12A of the heating chamber 12. The outlet 12A of the heating chamber 12 is attached to a valve member 14. The valve member 14 comprises a small opening. The valve member 14 helps maintain the pressure in the heating chamber 12. The opening in the valve member 14 allows a compressed stream of visible scent vapor to leave the device and move toward the target area to be sprayed.

FIG. 2 is a side cut away view of the Buck Fogger 100. FIG. 2 further discloses the manner in which the elements are connected. The liquid scent formulation is moved from the scent reservoir 10 to the heating chamber 12 by a pumping element 21, which is responsive to the control element 11. The pumping element 21 further comprises an inlet 21B and an outlet 21A. The pumping element inlet 21B is connected to the scent reservoir outlet 10A. The pumping element outlet 21A is connected to the heating chamber inlet 12B. In the present embodiment, the pumping element comprises two one way valves. The primary valve 21C is directly responsive to the control element 11. The primary valve 21C compresses and then uncompresses the area inside the pumping element 21, causing liquid scent to move from the scent reservoir 10 into the pumping element 21. The secondary valve 21D prevents the liquid scent from reentering the scent reservoir 10. As the area inside the pumping element 21 is continually compressed and uncompressed by the control element 11, the liquid scent is forced into the heating chamber inlet 12B. The pumping element 21 in the present embodiment functions in the same manner as a standard household spray bottle. However, the pumping element 21 may instead comprise any device that can pump liquid from a reservoir and force the liquid into a connected area.

The Buck Fogger 100 shown in FIGS. 1 and 2 can be held in the user's hand. The user can initiate the heating element 13 by starting the flow of fuel to the burner element 13A and manipulate the striking element 13B to start a combustion reaction in the heating element 13 to create heat. The user can then manipulate the control element 11 to move liquid scent from the scent reservoir 10 to the heating chamber 12. The liquid scent will be vaporized and the valve member 14 will pressurize the scent vapor leaving the device. The user may then point the device at the targeted area and spray the visible scent vapor. The scent will cover the targeted area and either attract or repel the intended game depending on the scent chosen as discussed above. The Buck Fogger is portable, lightweight, and useful for spraying remote areas.

In a preferred method of using the Buck Fogger 100, the user sprays the scent sprayer about five to ten times at a desired target area, and then turns the Fogger 100 off. Used in this manner, a forty ounce supply of scent formulation in the Fogger 100 can last for about three to four hunting trips.

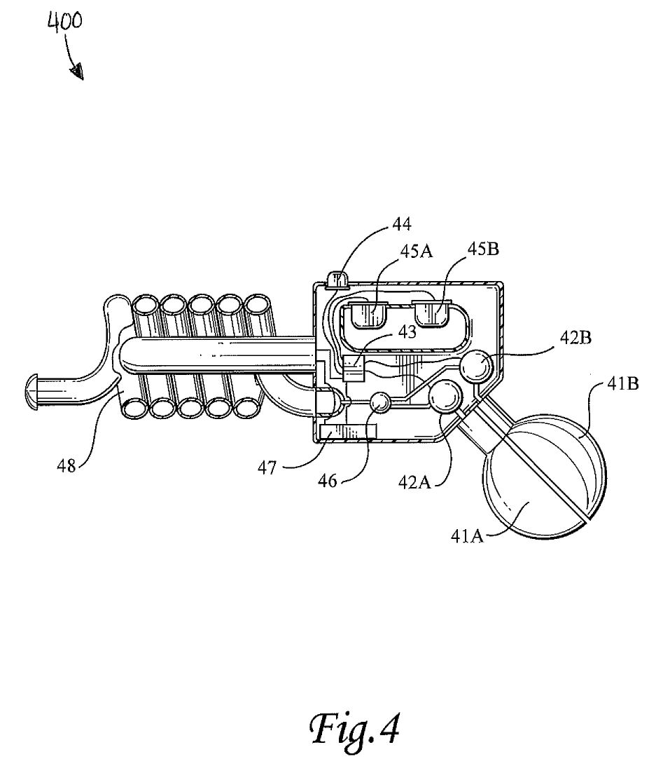

In an alternate embodiment, the scent reservoir 10 can be subdivided into two or more scent reservoirs to contain multiple scents. In this embodiment, the device should contain one pumping element 21 for each scent reservoir used. The control element should also be capable of controlling the flow of each scent independently of the others. The device should also contain an element to mix the scents prior to vaporization in a manner similar to the mixing element 46 disclosed in the third embodiment as depicted in FIG. 4 and described more fully below. For example, an oil based scent formulation and a water based formulation could be mixed immediately prior to vaporization.

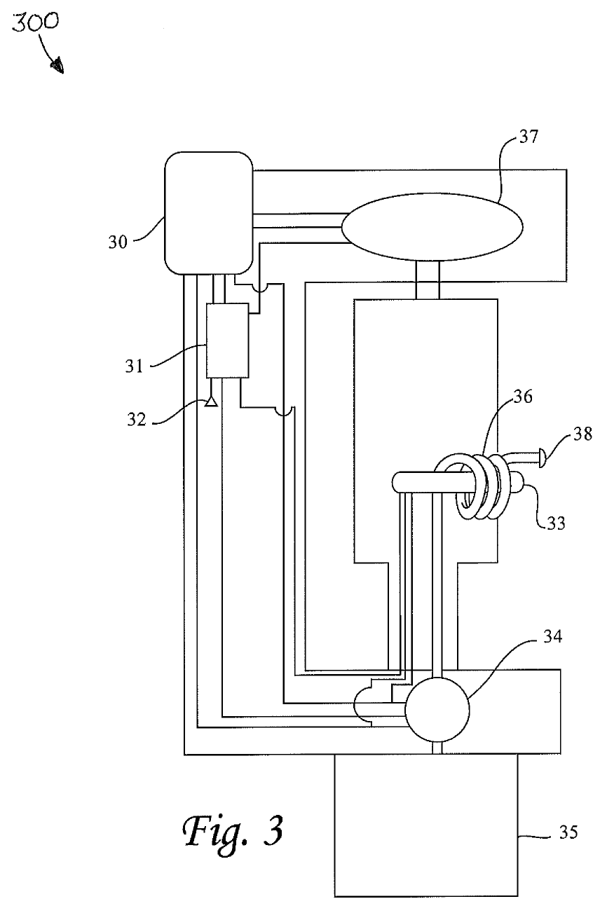

FIG. 3 illustrates a side cut away view of a Buck Fogger according to another embodiment of the invention, which is shown generally at reference numeral 300. The Buck Fogger 300 is designed to be placed at a fixed point and allowed to operate automatically by remotely transmitted commands or at specified intervals by instructions stored in the embodiment's memory. The Buck Fogger includes a power source 30, which is preferably a rechargeable battery. Depending on the embodiment used, the power source 30 may instead comprise any unit that receives alternating current and outputs direct current at voltage levels appropriate for the other components in the embodiment. The power source 30 is electrically connected to the other components in the embodiment as discussed below.

The Buck Fogger 300 also comprises a control element 31 electrically connected to the power source 30. Preferably, the control element 31 comprises a microchip. The control element 31 receives input from the user and controls the other components of the device. The control element 31 may comprise a programmable clock. In that embodiment, the control element 31 may perform preprogrammed actions at a specified time or at specified intervals. The actions of the control element 31 are discussed in greater detail below.

The control element 31 is electrically connected to one or more receiver elements 32. In the preferred embodiment, the receiver element 32 is an antenna. The antenna is responsive to a remote control, and transmits commands encoded as electrical signals to the control element 31. The receiver element 32 may also comprise a panel on the exterior of the device, for inputting commands to the control chip. The user may then input commands by pressing the buttons on the panel. In an alternate embodiment, the receiver element 32 consists only of the panel.

Once the control element 31 receives input from the receiver element 32, the control element 31 may then control the device by sending the appropriate signals to the connected components. Because of the actions taken by the control element 32, the device will react immediately, at a specified time, or at specified intervals depending on the commands given.

The Buck Fogger 300 comprises a heating element 33 electrically connected and responsive to the control element 31. The heating element 33 is also connected to the power source 30. The heating element 33 should be connected in such a way that the heating element 33 only receives power when given a signal by the control element 31. This operation may be accomplished by creating an open electrical connection between the heating element 33 and the power source 30 that is completed by the control element 31 or completed in response to a signal from the control element 31. In either case, upon the occurrence of the proper condition by the control element 31, the heating element 33 should be initiated and begin to produce heat. The production of heat may be accomplished by electrical resistance or any other method used to produce heat in an electric based heating system. The production of the heat by the heating element 33 starts the vaporization process in the same manner as in the non-automated embodiment.

The Buck Fogger 300 comprises a pumping element 34 which forces liquid scent from the scent reservoir 35 and into the heating chamber 36 in a manner similar to that used in the previous non automated embodiment. The pumping element 34 is electrically connected to the power source 30 and the control element 31. The pumping element 34 comprises a pumping system, such as a motor driven pump, that pumps the liquid scent upon receiving a signal from the control element 31. Alternatively, the scent reservoir 35 can be subdivided into two or more scent reservoirs to contain multiple scents. For example, an oil based scent formulation and a water based formulation could be mixed immediately prior to vaporization. In such an embodiment, there should be one pumping element 34 for each scent reservoir used. The control element 31 should also be capable of controlling the flow of each scent independently of the others. There should also be an element to mix the scents prior to vaporization in a manner similar to the mixing element 46 disclosed in the third embodiment as depicted in FIG. 4 and described more fully below.

The Buck Fogger further comprises an orientation element 37. In the preferred embodiment, the orientation element 37 is a stepper motor. The orientation element 37 is electrically connected to the power source 30, and the control element 31. The orientation element 37 is physically connected to the heating chamber 36. Upon receiving the appropriate signal from the control element 31, the orientation element 37 turns the heating chamber 36, thereby changing the heating chamber's 36 orientation. Changing the orientation of the heating chamber 36 and the attached valve member 38 redirects the scent vapor spray to a different target area.

The overall operation of the Buck Fogger 300 will now be summarized. The user may control the device by a remote control or through a panel. The commands will be transmitted from the receiver element 32 to the control element 31. The control element will interpret the signals based on said control element's 31 programming. At the appropriate time, based on the control element's 31 programming, the control element 31 will cause the pumping element 34 to force liquid scent retained in the scent reservoir 35 into the heating chamber 36. The control element 31 will also cause the heating element 33 to produce heat to begin the vaporization process in the heating chamber 36. The scent vapor will then leave the heating chamber 36 through the valve member 38. The control element 31 may also cause the orientation element 37 to turn to specific locations, in order to change the direction of the heating chamber 36, valve member 38, and the associated scent vapor spray. In this manner, the user may interact with the control element 31 to initiate the scent spray and the direction thereof.

FIG. 4 illustrates a side cut away view of a Buck Fogger according to another embodiment of the invention, which is shown generally at reference numeral 400. This embodiment is a combination of the previous two embodiments. The scent reservoir is subdivided into a first scent reservoir 41A and a second scent reservoir 41B. In this manner, the present embodiment can store two liquid scents at once. Alternate embodiments may also be created to store more scents and needed.

The Buck Fogger 400 comprises a power source 47 that functions in the same manner as power source 30 as discussed above. The power source 47 may be any power source that can provide the power needed by the other components of this embodiment.

The Buck Fogger 400 also comprises a control element, further comprising a microchip 43, a first manually operated trigger 45A, a second manually operated trigger 45B, and a third manually operated trigger 44. The microchip 43 of the control element is electrically connected to the power source 47. The microchip 43 is also electrically connected and responsive to each of the manually operated triggers. The microchip 43 is also connected to the pumping element 42, the heating element, and may also be connected to the mixing element 46 each as described below. The microchip 43 receives input from the trigger elements and sends signal to control the other elements based on said microchip's 43 predetermined programming.

In the present embodiment, the pumping element 42 further comprises a first pumping element 42A and second pumping element 42B. The pumping elements each further comprise a pumping system, such as a motor driven pump, that moves the liquid scent upon receiving a signal from the control element. The first pumping element 42A is connected to the first scent reservoir 41A. The second pumping element 42B is connected to the second scent reservoir 42B. Both pumping elements are electrically connected and responsive to the microchip 43 of the control element. Both pumping elements are also electrically connected to the power source 47. When one of the pumping elements receives a signal from the microchip 43 of the control element, that pumping element pumps liquid scent from the scent reservoir to which said pumping element is attached and into the mixing element 46 as discussed below. In this manner, the present embodiment can move one or both liquid scents from the scent reservoirs 41 to the mixing element 46.

The Buck Fogger also comprises a mixing element 46. The mixing element 46 receives liquid scent from each of the pumping elements 42, mixes any liquid scent received, and allows the resultant mixture to pass into heating chamber 48, said heating chamber 48 having the same functionality as heating chamber 36 and heating chamber 12 used in previous embodiments. The mixing element may be any device that would perform the previously mentioned function. The mixing element 46 may be a simple device such as a three way connector or more complex such as an electrical mixing system. If an electric mixing system is employed, the mixing element 46 should be electrically connected to both the power source 47 and the microchip 43 of the control element and responsive to said microchip 43. The embodiment of mixing element 46 chosen should mix the liquid scents in predetermined ratios, depending on the desired composition of the scent spray.

As stated previously, the microchip 43 of the control element receives input from and is responsive to the first, second, and third manually operated triggers of the control element. When the first manually operated trigger 45A is pressed by the user, the trigger sends a signal to the microchip 43, which sends a signal to the first pumping element 42A to begin pumping liquid scent from the first scent reservoir 41A. In the same manner, when pressed, the second manually operated trigger 45B sends a signal to the microchip 43, which sends a signal to the second pumping element 42B to begin pumping liquid scent from the second scent reservoir 41B. The third manually operated trigger 44 sends a signal to the microchip 43 to send a signal to the heating element to start the vaporization process in the same manner as the previous embodiments.

The overall operation of the Buck Fogger 400 will now be summarized. When the user presses the first manually operated trigger 45A, the second manually operated trigger 45B, or both, each pressed trigger sends a signal to the microchip 43. Depending on the signal or signals received, the microchip 43 sends a signal to the first pumping element 42A, the second pumping element 42B, or both. Any pumping element receiving a signal begins pumping liquid scent out of the scent reservoir to which said pumping element is attached. The liquid scent or scents are pumped into the mixing element 46. If two liquid scents are pumped into the mixing element 46, they are mixed in predetermined ratios. Additionally, the microchip 43 sends a signal to initiate the heating element to begin the vaporization process in the heating chamber 48. The scent mixture or scent from the mixing element 46 then enters the heating chamber 48 and is vaporized and spread in the same manner as in the previous embodiments. The power source 47 is connected to each component that needs power to function. It should be noted that FIG. 4 shows primarily the connections from the control element and omits many of the connections from the power source to the components. Those skilled in the art will understand that all components requiring electricity to function must be connected to the power source and a ground for the device to function as intended.

A wildlife scent formulation and method of using same are disclosed above. Various details of the invention may be changed without departing from its scope. The foregoing description of the invention and the best mode for practicing the invention are provided for the purpose of illustration only and not for the purpose of limitation—the invention being defined by the following claims and equivalents thereof.

What is claimed is:

1. A scent formulation comprising:
(a) a scent emitting substance;
(b) an oil;
(c) a surfactant; and
(d) wherein the scent formulation comprises a substantially stable emulsion.

2. A scent formulation according to claim 1, wherein the scent formulation is adapted for being used in a vaporizing device, and the emulsion remains substantially stable for at least an amount of time in which the scent formulation is to be used in the vaporizing device.

3. A scent formulation according to claim 1, wherein the scent emitting substance comprises at least one selected from the group consisting of animal urine, plant extract, artificial scent, natural scent and mixtures thereof.

4. A scent formulation according to claim 1, wherein the formulation is homogeneous, and the emulsion is selected from the group consisting of a micro-emulsion and a macro-emulsion.

5. A scent formulation according to claim 1, wherein the scent emitting substance comprises at least one selected from the group consisting of fox urine, coyote urine, deer urine, elk urine, moose urine, bear urine, rabbit urine, fish oils, sheep manure and mixtures thereof.

6. A scent formulation according to claim 1, wherein the formulation emits a scent that attracts at least one specie of animals.

7. A scent formulation according to claim 1, wherein the formulation emits a scent that repels at least one species of animals.

8. A scent formulation according to claim 1, wherein the formulation emits a scent that masks a human scent.

9. A scent formulation according to claim 1, further comprising a pesticide.

10. A scent formulation according to claim 1, wherein the oil comprises paraffin oil, the scent emitting substance comprises deer urine, and the surfactant comprises a 6-mole ethylene oxide adduct of nonylphenol.

11. A scent formulation according to claim 10, further comprising water, a tall oil fatty acid, and a high performance silicone defoamer.

12. A scent formulation according to claim 11, wherein the formulation comprises 10.0 percent by weight of the paraffin oil, 20.0 percent by weight of the deer urine, 4.0 percent by weight of the surfactant, 2.0 percent by weight of the tall oil fatty acid, and 0.1 percent of the defoamer.

13. A liquid scent formulation for use in a vaporizing device wherein the scent formulation is dispersed as a gas, comprising:
(a) a scent emitting substance;
(b) an oil;
(c) a surfactant; and
(d) characterized by the formulation comprising a stable emulsion wherein the scent emitting substance and the oil does not separate while the formulation is used with the vaporizing device.

14. A scent formulation according to claim 13, wherein the scent emitting substance comprises at least one at least one selected from the group consisting of animal urine, plant extract, artificial scent, natural scent and mixtures thereof, and the oil comprises at least one member selected from the group consisting of:
(a) vegetable oil, seed oil, paraffinic oil, and non water soluble solvent;
(b) fatty acids and blends thereof;
(c) esterified fatty acids or blends thereof;
(d) saponified fatty acids or blends thereof;
(e) N,N-dimethylamide of the formula
RCON(CH₃)₂
wherein R is an alkyl chain derived from a fatty acid having about 6 to about 18 carbon atoms; and
(f) polybutenes of the following formula 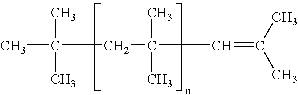
wherein n is a number from about 1 to about 50.

15. A scent formulation according to claim 12, wherein the surfactant comprises at least one selected from the group consisting of:
(a) fatty alkanolamides of the formula 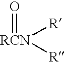
wherein R is an alkyl group having from about 6 to about 25 carbon atoms;
(b) PEG esters of the formula 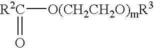
wherein R² is C₂-C₂₅ fatty alkyl having from about 2 to about 25 carbon atoms, R³ is a fatty alkyl having from about 2 to about 25 carbon atoms or hydrogen, and m is a number from 1 to about 100,
(c) silicone surfactants of the formula 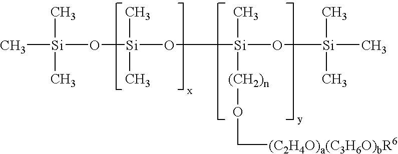
wherein x is a number from 0 to about 5, y is a number from 1 to about 5, a is a number from about 3 to about 25, b is a number from 0 to about 25, n is a number from about 2 to about 4, and R⁶ is hydrogen, an alkyl group having 1 to about 4 carbon atoms or an alkyl ester group having 1 to about 4 carbon atoms,
(d) ethoxylated fatty acids of the formula 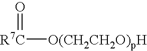
wherein R⁷ is an alkyl group having from about 6 to about 25 carbon atoms, p is a number from 1 to about 100,
(e) alkyl ethoxylates of the formula
R⁸O(CH₂CH₂O)_{q}H
wherein R⁸ is an alkyl group having from 1 to about 50 carbon atoms and q is
a number from 1 to about 100,
(f) alkylphenol ethoxylates of the formula 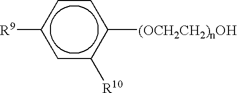
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 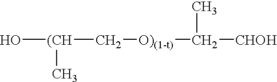
wherein t is a number from 1 to about 100,
(h) amine ethoxylates of the formula 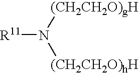
wherein g and h independently of one another are numbers from 1 to about 100 and R″ is an alkyl having from 1 to about 25 carbon atoms and
(i) tristyrylphenol alkoxylate;
(j) fatty alcohols;
(k) fatty ethers derived from fatty alcohols characterized by the formula ROR wherein R is an alkyl group containing from 4 to 22 carbon atoms;
i) glycerides derived from glycerol and C6-22 fatty acid.

16. A scent formulation according to claim 13, characterized wherein the scent formulation leaves a film upon contact when dispensed as a gas from the vaporizing device.

17. A scent formulation according to claim 16, characterized wherein the scent formulation comprises a visible fog when dispersed as a gas from the vaporizing device.

18. A method of using a scent formulation comprising the steps of:
(a) providing a liquid scent formulation comprising a scent emitting substance, at least one oil, at least one surfactant, wherein the scent formulation comprises a substantially stable emulsion; and
(b) providing a vaporizing device adapted for receiving the liquid scent formulation and emitting the scent formulation in a gaseous form;
(c) filling the vaporizing device with the liquid scent formulation; and
(d) emitting the scent formulation from the vaporizing device to disperse the scent formulation in a desired area.

19. A method according to claim 18, wherein the step of emitting the scent formulation from the vaporizing device comprises emitting the scent formulation as a visible fog.

20. A method according to claim 18, wherein the step of providing a vaporizing device comprises providing an apparatus comprising:
(a) at least one reservoir for receiving and storing the liquid scent formulation and including an outlet;
(b) a control element for controlling the flow of the liquid scent formulation;
(c) at least one pumping element comprising an inlet and an outlet, the inlet being connected to the outlet of the reservoir, and the pumping element operatively connected to the control element, wherein activation of the control element forces the liquid scent formulation out of the reservoir through the reservoir outlet into the pumping element;
(d) a heating chamber operatively connected to the pumping element for receiving the liquid scent formulation from the pumping element; and
(e) a heating element positioned proximate to the heating chamber for raising the temperature of the liquid scent formulation to vaporize the liquid scent formulation into the gaseous form.
